(19) United States
(12) Patent Application Publication
(10) Pub. No.: US 2012/0189449 A1
(43) Pub. Date: Jul. 26, 2012

(54) Alternative sail restraints for Migler's vertical axis wind turbine

(76) Inventor: Bernard Migler, Cherry Hill, NJ (US)

(21) Appl. No.: 12/931,037

(22) Filed: Jan. 24, 2011

(51) Int. Cl. F03D 11/00

(52) U.S. Cl. 416/132 B

(57) ABSTRACT

This disclosure presents several alternative setting and automatic resetting sail restraints for Migler's vertical axis wind turbine. They are designed to reduce the damaging impact of sail frames upon the structure of the wind turbine by absorbing some of the energy of the impact. Specifically, the disclosure includes spring loaded sail restraints, including motorized spring loaded sail restraints, a gravity-based sail restraint, including a motorized gravity-based sail restraint, a pneumatic sail restraint, including a motorized pneumatic sail restraint, a torsion bar sail restraint, and a motorized torsion bar sail restraint.

### STATEMENT REGARDING FEDERALLY SPONSORED RESEARCH OR DEVELOPMENT

There are no rights to this invention made under Federally sponsored research or development.

### FIELD OF THE INVENTION

[Note: The term “Migler's vertical axis wind turbine” or “Migler's wind turbine” as used in this application refers to the device disclosed in U.S. Pat. No. 6,926,491 B2 hereby incorporated by reference, and its modifications as disclosed in U.S. Pat. No. 7,334,994 B2, hereby incorporated by reference, as well as the modifications disclosed here.]

The devices disclosed here relate generally to the field of windmills or wind turbines for the production of electricity. More specifically they relate to the field of vertical axis wind turbines and more specifically to Migler's vertical axis wind turbine.

### BACKGROUND OF THE INVENTION

Migler's vertical axis wind turbine U.S. Pat. No. 6,926,491 B2, hereby incorporated by reference, discloses a vertical axis wind turbine, in which, when the wind speed becomes excessive it becomes necessary to feather all the sails to prevent damage to the sails. This is accomplished by rotating the sail restraints so that the sails are free to go into a feathered or “safe mode” position. The rotation can be accomplished either by manual means, that is by pulling cables that control the position of the sail restraints, or automatically by operation of motorized sail restraint controllers. The latter method requires the monitoring of the wind speed by an anemometer, control circuitry to take the data from the anemometer and then, if the wind speed is excessive, signal the motorized sail restraint controllers to rotate the sail restraints. Both methods are less than satisfactory. The manual means (pulling the cables) requires human attendance and intervention, while the operation of the motorized sail restraint controllers requires the addition of sensors for wind speed, control circuitry and motors, which add cost and complexity to the device. A third problem is that the resetting of the sail restraints by the motorized sail restraint controllers when the wind speed is reduced to allowable levels is not automatic and could result in some of the sails being trapped in the feathered position, that is, on the “wrong” side of the sail restraints. For the device to become practical these problems must be solved. Migler solved these problems as disclosed in U.S. Pat. No. 7,334,994 B2, hereby incorporated by reference. In that disclosure several automatic self-feathering and resetting sail restraints for Migler's vertical axis wind turbine were described.

The inventions described here go further and disclose two additional automatic setting and resetting sail restraints that are useful for Migler's vertical axis wind turbine. Migler's patent (U.S. Pat. No. 6,926,491 B2) did not provide protection from the damaging effect of the repeated impact of the sail frames against the sail restraints. The invention disclosed here solves this problem.

The use of pneumatic, gravity-based and torsion bar shock absorbing sail restraints are also disclosed here.

### BRIEF SUMMARY OF THE INVENTION

The inventions disclosed here provide for the protection of Migler's vertical axis wind turbine from the damaging effect of the repeated impact of sail frames against the sail restraints. This protection is accomplished by several alternative means of spring-loading a sail restraint so that the springs absorb some of the energy of the impact.

The inventions disclosed here also include alternative setting and resetting sail restraints for Migler's vertical axis wind turbine as disclosed in U.S. Pat. No. 6,926,491 B2.

Another invention disclosed here is an alternative setting and resetting sail restraint with a motorized “flapper-lifter.”

Another invention disclosed here is a pneumatic shock absorbing sail restraint for the protection of Migler's wind turbine from the damaging effect of the repeated impact of sail frames against the sail restraints.

Another invention disclosed here is a gravity-based shock absorbing sail restraint for the protection of Migler's wind turbine from the damaging effect of the repeated impact of sail frames against the sail restraints.

Another invention disclosed here is a torsion bar shock absorbing sail restraint for the protection of Migler's wind turbine from the damaging effect of the repeated impact of sail frames against the sail restraints.

### BRIEF DESCRIPTION OF THE DRAWINGS

The invention is not intended to be limited to the precise arrangements and instrumentalities shown.

FIG. 1, identified as prior art in the figure, is a three dimensional view of Migler's wind turbine, as disclosed in U.S. Pat. No. 6,926,491 B2, hereby incorporated by reference. The wind turbine produces electricity when wind rotates the device, causing electricity to be generated by its dynamo. The reader is referred to U.S. Pat. No. 6,926,491 B2 for a full description of the device and its operation.

FIG. 2, identified as prior art in the figure, is a side view of an automatic self-feathering and resetting sail restraint for Migler's vertical axis wind turbine as disclosed in (U.S. Pat. No. 7,334,994 B2.) The reader is referred to that patent for a full description of the device and its operation.

FIG. 3A, 3B and 3C are side views three embodiments of motorized sail restraints similar to the type disclosed by Migler in U.S. Pat. No. 6,926,491 B2, but having spring loaded vertical members to protect them against damage due to the impact of sail frames during normal operation.

FIG. 4A, 4B and 4C are a sequence of side views showing the operation of an automatic setting and resetting sail restraint. FIG. 4A shows the normal operation of the sail restraint. FIG. 4B shows the operation during excessive wind and FIG. 4C shows the automatic resetting of the sail restraint after excessive wind.

FIG. 5A, 5B and 5C are a sequence of side views showing the operation of another automatic setting and resetting sail restraint. FIG. 5A shows the normal operation of the sail restraint. FIG. 5B shows the operation during excessive wind. FIG. 5C shows the operation of a motorized flapper-lifter, allowing a sail frame to pass by without impacting the flapper. In addition, but not shown in FIG. 5C, when the flapper is not raised, then the sail restraint may be automatically reset after excessive wind, by the same means as shown in FIG. 4C.

FIG. 6 (A, and B) is a drawing of a cross-sectional side view of a pneumatic shock-absorbing sail restraint. FIG. 6C is a drawing of a cross-sectional view of a motorized pneumatic shock absorbing sail restraint.

FIG. 7A, B, and C are drawings of a cross-sectional side view of a gravity-based shock-absorbing sail restraint.

FIG. 7D is a drawing of a cross-sectional side view of a motorized gravity-based shock-absorbing sail restraint.

FIG. 8A, B, C and D are drawings of a cross-sectional side view of a torsion bar shock-absorbing sail restraint.

FIG. 8E is a drawing of a cross-sectional side view of a motorized torsion bar shock-absorbing sail restraint.

### DETAILED DESCRIPTION OF THE DRAWINGS

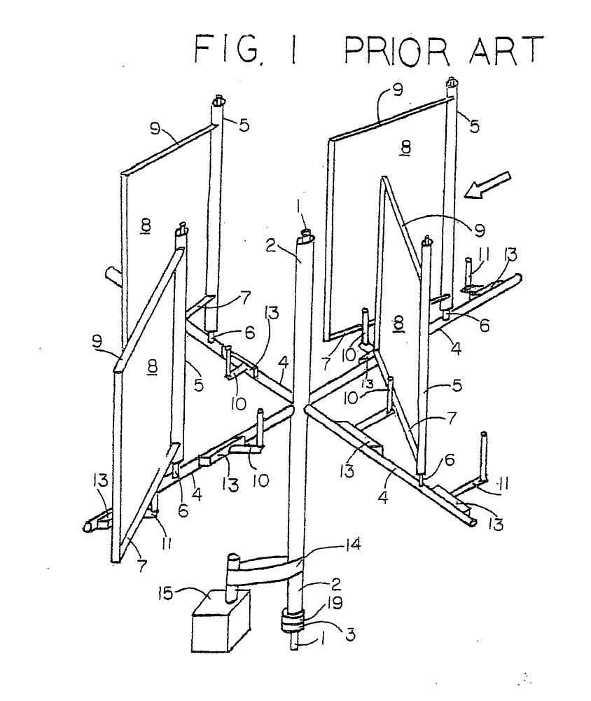

1) Referring now to the drawing in FIG. 1 there is shown a three dimensional drawing of Migler's vertical axis wind turbine as prior art. The reader is referred to U.S. Pat. No. 6,926,491B2 for a complete description of the device and its operation. For the purpose of the present inventions, note in particular that wind coming from the direction indicated by the arrow causes the rotation of the tower collar 2 around the tower 1. The tower collar 2 causes rotation of a driving belt 14 to operate a dynamo/generator 15, producing electricity. Motorized sail restraint controllers 13 are able to rotate the sail restraints 10 and 11 so that the sail frames do not impact the sail restraints, thereby putting the windmill into a safe mode. There is no protection of the sail restraints 10 and 11 from damage due to excessive force from the impact of the sail frames. This problem is corrected in this disclosure by alternative sprint-loaded, gravity-based and pneumatic shock absorbing sail restraints.

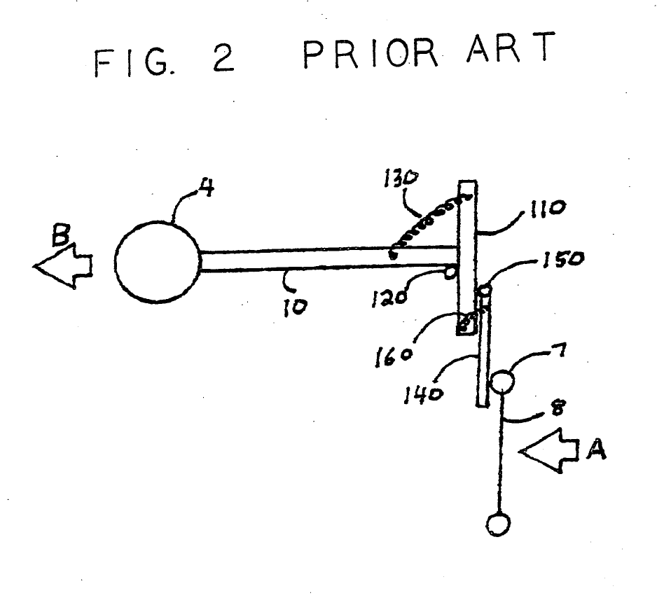

FIG. 2, identified as prior art in the figure, is a side view of an automatic self-feathering and resetting sail restraint for Migler's vertical axis wind turbine, as disclosed in U.S. Pat. No. 7,334, 994 B2, hereby incorporated by reference. Wind, indicated by arrow A, causes a sail 8 and its sail frame 7 to strike a flapper 140, driving the sail restraint rearward, as indicated by arrow B, causing rotation of the windmill. If the wind is of sufficient strength the flapper 140 can bend sufficiently allowing the sail 8 and sail frame 7 to pass by, putting the windmill into “safe mode” in which the sails are feathered, that is, they act as “weathervanes”, pointing downwind and offering little or no resistance to the wind; this halts the rotation of the windmill. When the wind eventually reverses direction and pushes the sail 8 and its sail frame 7 against the rear of the flapper 140, (not shown) the sail and sail frame easily passes by the flapper into normal operating position.

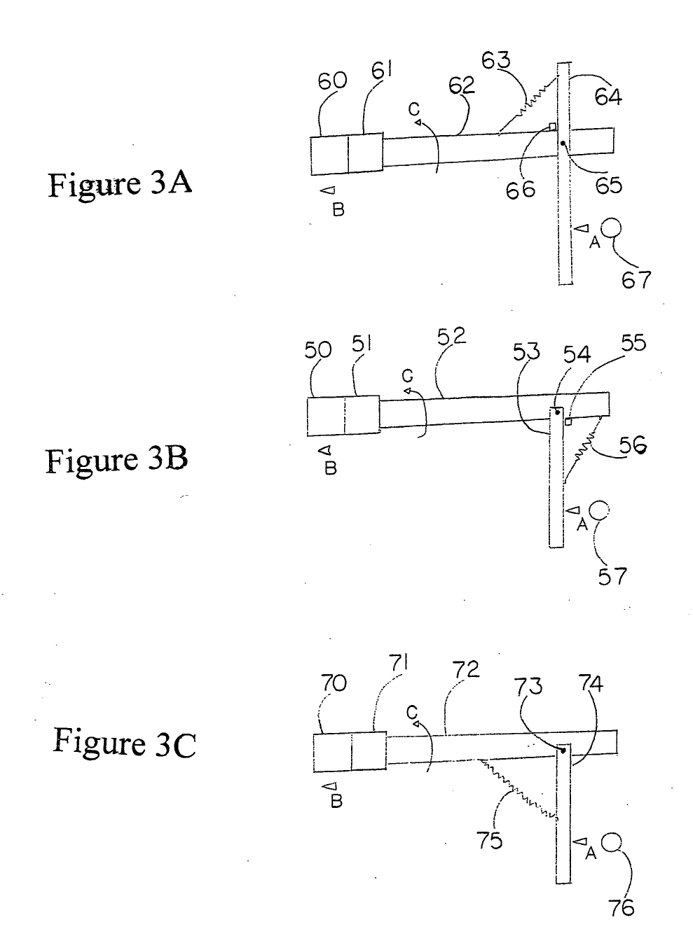

Referring now to the drawings in FIGS. 3A, 3B and 3C, there are shown three variations of Migler's original motorized sail restraints as disclosed in U.S. Pat. No. 6,926,491B2. Each of the three is designed to solve the problem of the damaging effect of the constant impact of a sail frame against a sail restraint and its motorized controller. FIG. 3A shows a side view of a motorized sail restraint controller 61 secured to a horizontal arm 60 of Migler's windmill. A rotatable sail restraint arm 62 is secured to the motorized sail restraint controller 61. A rotatable vertical arm 64 is secured to the rotatable sail restraint arm 62 by a joint 65. An expansion spring 63 and a restraint block 66 mounted behind the rotatable vertical arm 64 hold the vertical arm securely in place. When a sail frame 67 impacts the rotatable vertical arm 64 as indicated by arrow A, the expansion spring 63 absorbs some of the energy of the impact, reducing potential damage to the device. The rotatable sail restraint arm 62 may be rotated by the motorized sail restraint controller 61, as indicated by arrow C, so that a sail frame cannot impact the rotatable vertical arm 64, thereby putting the windmill into safe mode.

Referring now to the drawings in FIG. 3B there is shown a side view of a motorized sail restraint controller 51 secured to a horizontal arm 50 of Migler's windmill. A rotatable sail restraint arm 52 is secured to the motorized sail restraint controller 51. A rotatable vertical arm 53 is secured to the rotatable sail restraint arm 52 by a joint 54. An expansion spring 56 and a restraint block 55 mounted in front of the rotatable vertical arm 53 hold the rotatable vertical arm 53 securely in place. When a sail frame 57 impacts the rotatable vertical arm 53 as indicated by the arrow A, the expansion spring 56 absorbs some of the energy of the impact, reducing potential damage to the device. The rotatable sail restraint arm 52 may be rotated by the motorized sail restraint controller 51, as indicated by arrow C, so that a sail frame cannot impact the rotatable vertical arm 53, thereby putting the windmill into safe mode.

Referring now to the drawings in FIG. 3C there is shown a side view of a motorized sail restraint controller 71 secured to a horizontal arm 70 of Migler's windmill. A rotatable sail restraint arm 72 is secured to the motorized sail restraint controller 71. A rotatable vertical arm 74 is secured to the rotatable sail restraint arm 72 by a joint 73. A compression spring 75 behind the rotatable vertical arm 74 holds the rotatable vertical arm 74 securely in place. When a sail frame 76 impacts the rotatable vertical arm 74 as indicated by the arrow A, the compression spring 75 absorbs some of the energy of the impact, reducing potential damage to the device. The rotatable sail restraint arm 72 may be rotated by the motorized sail restraint controller 71, as indicated by arrow C, so that a sail frame cannot impact the device, thereby putting the windmill into safe mode.

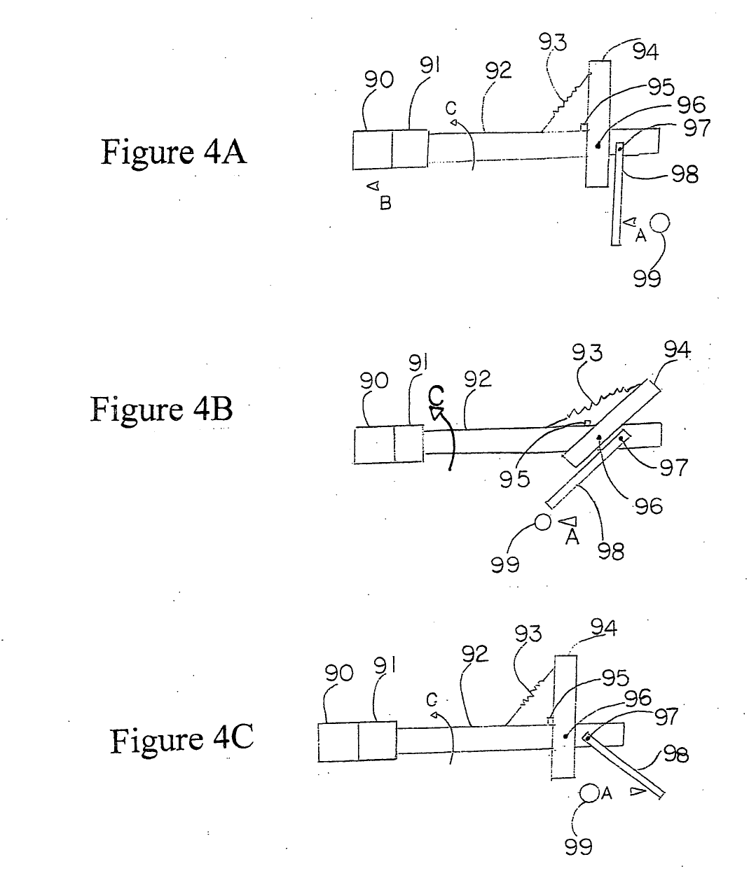

Referring now to FIGS. 4A, 4B and 4C there is shown a sequence of three side view drawings of the operation of an automatic self-feathering and resetting sail restraint for Migler's vertical axis windmill. In FIGS. 4A, 4B and 4C a motorized sail restraint controller 91 is secured to a horizontal arm 90 of Migler's vertical axis windmill. A rotatable sail restraint arm 92 is secured to the motorized sail restraint controller 91. A main rotatable vertical member 94 is secured to the rotatable sail restraint arm 92 by a joint 96. An expansion spring 93 and a restraint block 95 keep the main vertical member securely in place. A member referred to here as a “flapper” 98 is secured to the rotatable sail restraint arm 92 by a joint 97.

The drawing in FIG. 4A indicates that when a sail frame 99 impacts the flapper 98 as indicated by arrow A the device is driven in the direction shown by arrow B, causing rotation of the windmill.

The drawing in FIG. 4B indicates that when a sail frame 99 impacts the flapper 98 with great force, due to high wind speed, the expansion spring 93 is stretched sufficiently so that the sail frame 99 can pass by the flapper, as indicated by arrow A. When this happens the windmill is put into safe mode. The expansion spring 93 then contracts, returning the main vertical member 94 and flapper arm 98 to return to their normal operating position

The drawing in FIG. 4C indicates the effect upon the device of the eventual reversal of the wind direction. In this case when the frame of a sail 99 impacts the flapper 98 from the opposite side as that shown in FIG. 4B, and by arrow A, the flapper 98 offers no resistance, having no spring loading, and the frame 99 passes through the device into normal operating mode.

The rotatable sail restraint arm 92 may be rotated by the motorized sail restraint controller 91, as indicated by arrow C, so that a sail frame 99 cannot impact the device, thereby putting the windmill into safe mode.

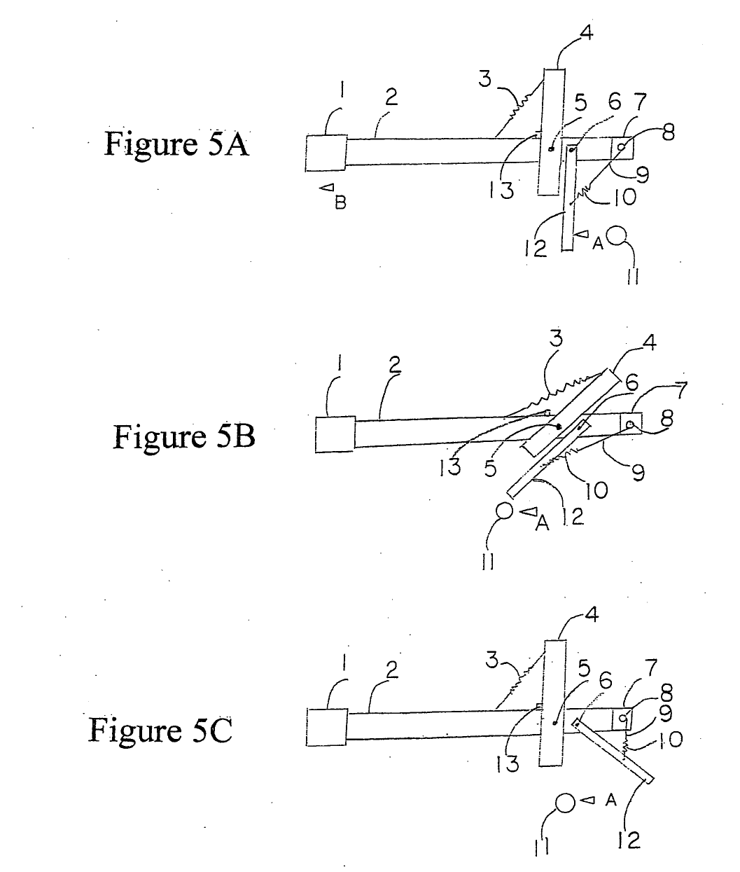

Referring now to FIGS. 5A, 5B and 5C there is shown a sequence of three side view drawings of the operation of another automatic self-feathering and resetting sail restraint for Migler's vertical axis windmill. In FIGS. 5A, 5B and 5C a sail restraint arm 2 is secured to a horizontal arm 1 of Migler's vertical axis windmill. A main vertical member 4 is secured to the sail restraint arm 2 by a joint 5. An expansion spring 3 and restraint block 13 hold the main vertical member 4 securely in place. A member referred to here as a “flapper” 12 is secured to the sail restraint arm 2 by a joint 6. The flapper 12 is secured by a flexible line 9 to a motorized “flapper-raiser” 7 and its take-up reel 8. The flexible line 9 has a spring 10 to absorb shock.

In another embodiment the motorized flapper-raiser 7 rotates the joint 6, to which the flapper 12 is secured to raise the flapper (not shown.)

In another embodiment the motorized flapper-raiser 7 is secured to the main vertical member 4.

The drawing in FIG. 5A indicates that when a sail frame 11 of a sail impacts the flapper 12 as indicated by arrow A the device is driven in the direction shown by arrow B, causing rotation of the windmill.

When the wind eventually reverses direction a sail frame 11 may impact the flapper 12 from the opposite side as that shown in the FIG. 5A, and since the flapper 12 offers no resistance, having no spring loading, the frame 11 passes through the device into normal operating mode (not shown) but similar to the function shown in FIG. 4B.

FIG. 5C shows the flapper 12 raised by the flapper-raiser 7 and its take-up reel 8. When the flapper 12 is raised the windmill goes into safe mode since a sail frame 11 will pass by the flapper 12 as shown by arrow A and cannot impact the flapper.

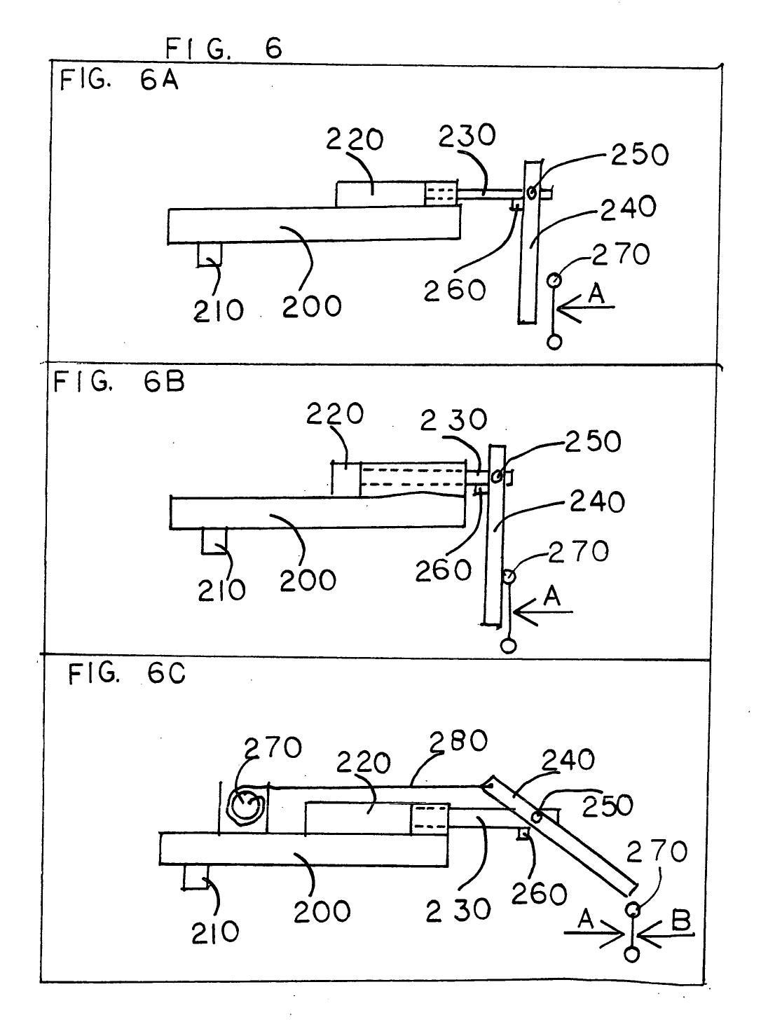

Referring now to the drawings in FIG. 6A, B and C in detail, there are shown cross sectional views of a pneumatic shock-absorbing sail restraint. In FIG. 6A a sail restraint arm 200 is secured to a horizontal arm 210 of Migler's vertical axis windmill. A gas-filled cylinder 220 and piston 230 of a pneumatic shock absorber is secured to the sail restraint arm 200. A hanging sail restraint 240 is rotatably secured to said piston 230 by a joint 250. Arrow A indicates the impending impact of a sail frame 270 against the hanging sail restraint 240. A limiter 260 prevents the rearward motion of said hanging sail restraint 240 during impact.

In FIG. 6B the effect of the impact of a sail fame 270 (arrow A) against the hanging sail restraint 240 is illustrated. The piston 230 is driven into the gas-filled cylinder 220. The compressed gas subsequently drives the piston 230 outward in preparation for the next impact. In FIG. 6C a cable 280 connects the hanging sail restraint 240 to a motorized take-up reel 270. Operation of the motorized take-up reel 270 pulls up the hanging sail restraint 240, as shown, so that a sail frame 270 will pass freely in either direction, as shown at arrows A and B.

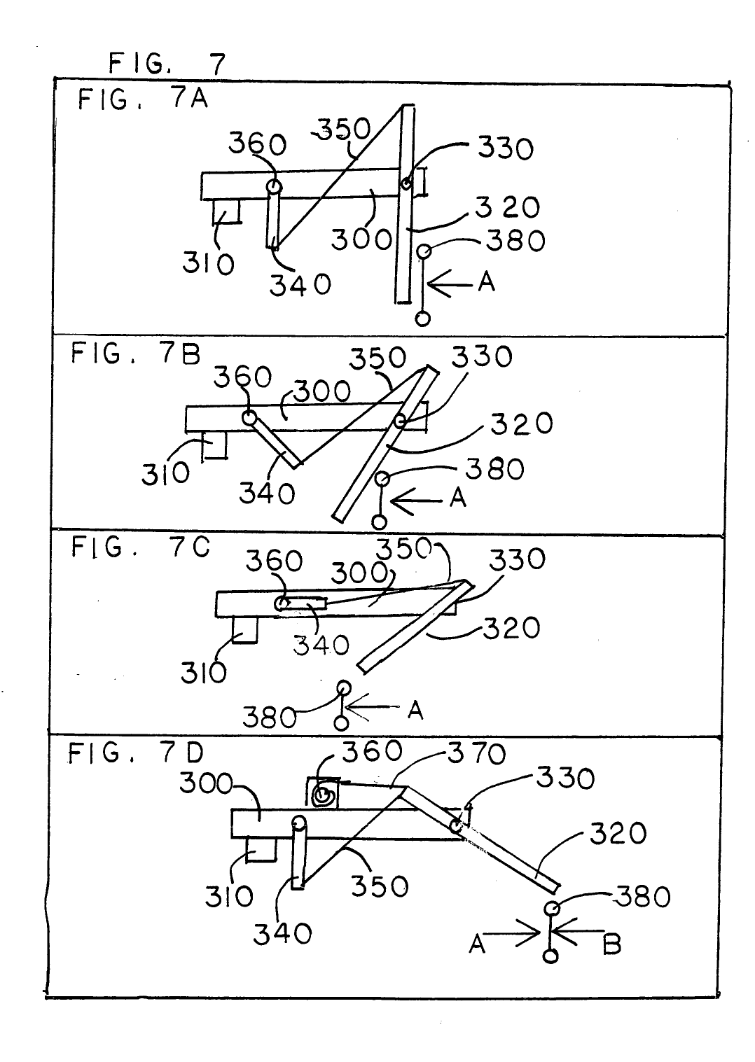

Referring now to the drawings in FIG. 7A, B, C and D in FIG. 7 in detail, there are shown cross sectional side views of a gravity-based shock-absorbing sail restraint. In FIG. 7A a sail restraint arm 300 is secured to a horizontal arm 310 of Migler's vertical axis windmill. A weight 340 is secured to the sail restraint arm 300 by a joint 360. A hanging sail restraint 320 is rotatably secured to the sail restraint arm 300 by a joint 330. The weight 340 is connected to the hanging sail restraint by a cable 350. Arrow A indicates the impending impact of a sail frame 380 against the hanging sail restraint 320.

In FIG. 7B the effect of the impact of a sail fame 380 (arrow A) against the hanging sail restraint 320 is illustrated. The impact of the sail frame 380 against the hanging sail restraint 320 lifts the weight 340, absorbing some of the shock.

FIG. 7C illustrated the ability of a sail frame 380 to drive past the hanging sail restraint 320 and into a safe condition when there is excessive wind.

In FIG. 7D a cable 370 connects the hanging sail restraint 320 to a motorized take-up reel 360. Operation of the motorized take-up reel 360 pulls up the hanging sail restraint 320, as shown, so that a sail frame 380 may pass freely in either direction, as shown at arrows A and B.

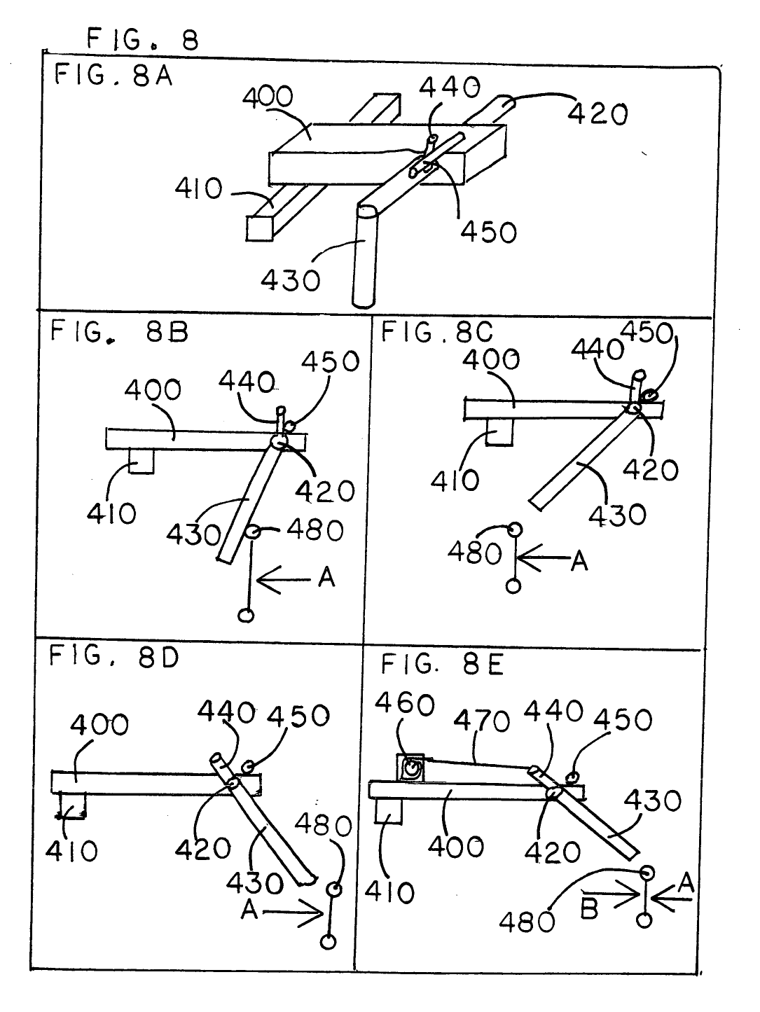

Referring now to the drawings in FIG. 8 in detail, there is shown in FIGS. 8A, B, C, D and E a three dimensional cross sectional view of a torsion bar shock-absorbing sail restraint. A sail restraint arm 400 is secured to a horizontal arm 410 of Migler's vertical axis windmill. A torsion bar 420 is rotatably secured to the sail restraint arm 400. A hanging arm 430 and a pin 440 are secured to the torsion bar 420. Rotation of the torsion bar 420 rearward (toward the horizontal arm 410) when impacted by a sail frame 480 against the hanging arm 430 (as shown in FIG. 8B) is impeded by a rotation limiter 450. The limiter 450 does not block rotation of the torsion bar 420 when the hanging arm 430 is impacted by a sail frame 480 striking in the opposite direction (as shown in FIG. 8D.)

FIG. 8B illustrates the effect of a sail frame 480 striking the hanging arm 430 as shown at arrow A. The limiter 450 blocks the pin 440 on the torsion bar 420 causing energy to be stored in the torsion bar.

FIG. 8C illustrates the effect when wind of very high energy causes the fame of a sail 480 to push past the hanging arm 430. The torsion bar 420 rotates sufficiently, absorbing energy, to allow the sail frame 480 to pass, as shown at arrow A. This action puts the wind turbine into “safe” mode, preventing damage to the wind turbine. FIG. 8D illustrates the means whereby the wind turbine resumes normal functioning after being placed in safe mode. When wind causes a sail frame 480 to strike the hanging arm 430 in the rear (that is, in the opposite direction from that shown in FIG. 8C) the torsion bar 420 is able to rotate freely, since the pin 440 is not blocked by the limiter 450. The sail frame 480 then passes by the hanging arm 430, as shown at arrow A, into the normal operating position.

In FIG. 8E a cable 470 connects the pin 440 to a motorized take-up reel 460. Operation of the motorized take-up reel 460 rotates the torsion bar 420 and its hanging arm 430 so that a sail frame 480 can pass freely in either direction, as shown at arrows A and B.

I claim:

1. A sail restraint device for Migler's vertical axis wind turbine comprising:
a) a motorized sail restraint controller secured to a horizontal arm of said Migler's vertical axis wind turbine,
b) a rotatable sail restraint arm secured to said motorized sail restraint controller, and able to be rotated by said motorized sail restraint controller,
c) a unidirectionally rotatable vertical arm secured to said rotatable sail restraint arm,
d) an expansion spring connecting said rotatable vertical arm to said rotatable sail restraint arm,
e) a restraint, preventing rotation of said rotatable vertical arm from rotating in the direction toward said horizontal arm of Migler's vertical axis wind turbine,
whereby when a sail frame of Migler's vertical axis wind turbine impacts said rotatable vertical arm in the direction toward said horizontal arm of Migler's vertical axis wind turbine, the expansion spring absorbs some of the energy, and
whereby when said rotatable sail restraint arm is rotated by said motorized sail restraint controller a sail frame cannot impact said rotatable vertical arm.

2. A sail restraint device for Migler's vertical axis wind turbine comprising:
a) a motorized sail restraint controller secured to a horizontal arm of said Migler's vertical axis wind turbine,
b) a rotatable sail restraint arm secured to said motorized sail restraint controller, and able to be rotated by said motorized sail restraint controller,
c) a rotatable vertical arm secured to said rotatable sail restraint arm,
d) an compression spring connecting said rotatable vertical arm to said rotatable sail restraint arm,
e) a restraint block,
d. whereby when a sail frame of Migler's vertical axis wind turbine impacts said rotatable vertical arm, said compression spring absorbs some of the energy, and
whereby when said rotatable sail restraint arm is rotated by said motorized sail restraint controller a sail frame cannot impact said rotatable vertical arm.

3. A sail restraint device for Migler's vertical axis wind turbine comprising:
a) a motorized sail restraint controller secured to a horizontal arm of said Migler's vertical axis wind turbine,
b) a rotatable sail restraint arm secured to said motorized sail restraint controller, and able to be rotated by said motorized sail restraint controller,
c) a main rotatable vertical member secured to said rotatable sail restraint arm,
d) an expansion spring connecting said main rotatable vertical member to said rotatable sail restraint arm,
e) a restraint, preventing rotation of said main rotatable vertical member by said
c.
ci. expansion spring,
f) a flapper secured to said rotatable sail restraint arm by a joint, able to rotate in one direction when impacted by a sail frame of Migler's vertical axis wind turbine to push said main rotatable vertical member, and able to swing in the opposite direction and not push said main rotatable vertical member,
whereby when a sail frame of Migler's vertical axis wind turbine, moving toward said horizontal arm impacts said flapper said main vertical member is pushed, stretching said expansion spring, absorbing some of the energy of said impact, and
whereby when said rotatable sail restraint arm is rotated by said motorized sail restraint controller a sail frame cannot impact said flapper, and
whereby when a sail frame moving away from said horizontal arm impacts said flapper said sail frame is able to push past said flapper.

4. A sail restraint device for Migler's vertical axis wind turbine comprising:
a) sail restraint arm secured to a horizontal arm of Migler's vertical axis wind turbine,
b) a rotatable main vertical member,
c) an expansion spring connecting said rotatable main vertical member to said sail restraint arm,
d) a restraint, preventing said main vertical member from being rotated by said expansion spring,
e) a rotatable flapper, secured to said sail restraint arm, able to rotate in one direction when impacted by a sail frame of Migler's vertical axis wind turbine to push said main rotatable vertical member, and able to swing in the opposite direction and not push said main rotatable vertical member
f) a motorized flapper-raiser, connected to said rotatable flapper, and able to raise said rotatable flapper,
whereby when a sail frame of Migler's vertical axis wind turbine, moving toward said horizontal arm impacts said flapper said main vertical member is pushed, stretching said expansion spring, absorbing some of the energy of said impact, and
whereby when a sail frame moving away from said horizontal arm impacts said flapper said sail frame is able to push past said flapper, and
whereby when said flapper is raised by said motorized flapper-raiser a sail frame cannot impact said flapper.

5. A pneumatic shock-absorbing sail restraint device for Migler's vertical axis wind turbine comprising:
a) sail restraint arm secured to a horizontal arm of Migler's vertical axis wind turbine,
b) a gas-filled cylinder and piston secured to said sail restraint arm,
c) a rotatable hanging sail restraint secured to said piston,
d) a rotation limiter, preventing rotation of said hanging sail restraint in the direction toward said horizontal arm,
whereby when a sail frame from Migler's vertical axis wind turbine impacts said hanging sail restraint, in the direction toward said horizontal arm, said piston is driven back into said gas-filled cylinder, absorbing some energy, and
whereby when a sail frame from Migler's vertical axis wind turbine impacts said hanging sail restraint in the direction away from said horizontal arm, said hanging sail restraint is able to rotate.

6. The device of claim 5, having:
a) a motorized take-up reel secured to said horizontal arm,
b) a cable connecting said motorized take-up reel to said rotatable hanging sail restraint, able to lift said rotatable sail restraint,
whereby when a sail frame from Migler's vertical axis wind turbine impacts said hanging sail restraint, in the direction toward said horizontal arm, said piston is driven back into said gas-filled cylinder, absorbing some energy, and
whereby when a sail frame from Migler's vertical axis wind turbine impacts said hanging sail restraint in the direction away from said horizontal arm, said hanging sail restraint is able to rotate and,
whereby sail motorized take-up reel is able to lift said hanging sail restraint, so that a sail frame from Migler's vertical axis wind turbine is not able to impact said hanging sail restraint.

7. A gravity-based sail restraint device for Migler's vertical axis wind turbine comprising:
a) sail restraint arm secured to a horizontal arm of Migler's vertical axis wind turbine,
b) a rotatable weight secured to said sail restraint arm,
c) a rotatable hanging sail restraint secured to said sail restraint arm,
d) a cable, connecting said rotatable weight to said hanging sail restraint,
whereby when a sail frame from Migler's vertical axis wind turbine impacts said rotatable hanging sail restraint, said weight is rotated and lifted, absorbing some energy.

8. The device of claim 7, having:
a) a motorized take-up reel secured to said sail restraint arm,
b) a cable connecting said motorized take-up reel to said rotatable hanging sail restraint, able to rotate and lift said rotatable hanging sail restraint,
whereby when a sail frame from Migler's vertical axis wind turbine moving in the direction toward said horizontal arm impacts said rotatable hanging sail restraint, said weight is lifted, absorbing some energy and
whereby when a sail frame from Migler's vertical axis wind turbine moving in the direction away from said horizontal arm impacts said rotatable hanging sail restraint, said rotatable hanging sail restraint is pushed forward, allowing said frame of Migler's vertical axis wind turbine to pass by and
whereby said rotatable hanging sail restraint may be rotated and lifted by activation of said motorized take up reel, allowing said frame of Migler's vertical axis wind turbine to pass by.

9. A torsion bar shock absorbing sail restraint device for Migler's vertical axis wind turbine comprising:
a) sail restraint arm secured to a horizontal arm of Migler's vertical axis wind turbine,
b) a unidirectionally rotatable torsion bar, secured to said sail restraint arm, able to rotate only in the direction away from said horizontal arm,
c) a hanging arm, secured to said torsion bar,
whereby when a sail frame from Migler's vertical axis wind turbine moving in the direction toward said horizontal arm impacts said hanging arm, said torsion bar is unable to rotate, but is twisted, absorbing some energy of the impact, and
whereby when a sail from Migler's vertical axis wind turbine impacts said hanging arm in the direction, away from said horizontal arm, said hanging arm and torsion bar are able to rotate freely in the direction away from said horizontal arm and out of the way of the sail frame.

10. The device of claim 9, having:
a) a pin on said torsion bar,
b) a motorized take-up reel secured to said sail restraint arm,
c) a cable from said motorized take-up reel to said pin, enabling said motorized take-up reel to rotate said torsion bar in the direction away from said horizontal arm and able to raise said hanging arm,
whereby when a sail from Migler's vertical axis wind turbine moving in the direction toward said horizontal arm impacts said hanging arm, said torsion bar cannot rotate, but is twisted, absorbing some energy of the impact, and
whereby when a sail from Migler's vertical axis wind turbine impacts said hanging arm in the direction away from said horizontal arm, said hanging arm and torsion bar are able to rotate freely out of the way of said sail frame, and
whereby when said motorized take-up reel is activated, said torsion bar is rotated and said hanging arm is lifted out of the way of said sail frame.
